(19) United States
(12) Patent Application Publication
(10) Pub. No.: US 2009/0242142 A1
(43) Pub. Date: Oct. 1, 2009

(54) PRIVACY SCREEN FOR A DISPLAY DEVICE

(75) Inventors: Thomas A. Bellwood, Austin, TX (US); Jacob D. Eisinger, Austin, TX (US); Matthew F. Rutkowski, Pflugerville, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/060,634

(22) Filed: Apr. 1, 2008

(51) Int. Cl. E06B 9/24

(52) U.S. Cl. 160/127

(57) ABSTRACT

A privacy screen for a display device includes a frame having first and second opposing members joined by third and fourth opposing members that collectively define a central opening. The privacy screen further includes a transparent film extending across the central opening. The transparent film includes a plurality of vertical micro-louvers. The plurality of vertical micro-louvers are arranged in at least one of a first configuration wherein the plurality of micro-louvers are positioned at variable angles relative to a vertical fixed reference point, a second configuration wherein the plurality of micro-louvers have varying depths relative to the vertical fixed reference point, and a third configure wherein a spacing between adjacent ones of the plurality of micro-louvers varies relative to the vertical fixed reference point.

### BACKGROUND OF THE INVENTION

This invention relates to the art of display devices and, more particularly, to a privacy screen for a display device.

### DESCRIPTION OF BACKGROUND

Conventional privacy screens for monitors which are based on vertical micro-louvers, act to columnate light emanating from a display device such that the light attenuates rapidly in a horizontal plane relative to the screen. By virtue of the vertical configuration of the micro-louvers, light intensity across the privacy screen varies along the horizontal plane when viewed from a single reference point in front of the screen. That is, the micro-louvers deflect more light at side portions of the privacy screen than at a central portion of the screen. Therefore, when scanning a line of text, a user must make constant eye adjustments in order to accommodate the varying light levels. Constantly making eye adjustments in this manner creates eye strain which often times results in discomfort. In any case, many users who would otherwise benefit from the use of a privacy screen choose to go without due to the perceived discomfort.

### SUMMARY OF THE INVENTION

The shortcomings of the prior art are overcome and additional advantages are provided through the provision of a privacy screen for a display device constructed in accordance with exemplary embodiments of the present invention. The privacy screen includes a frame having first and second opposing members joined by third and fourth opposing members that collectively define a central opening. The privacy screen further includes a transparent film extending across the central opening. The transparent film includes a plurality of vertical micro-louvers. The plurality of micro-louvers are arranged in at least one of a first configuration wherein the plurality of micro-louvers are positioned at variable angles relative to a vertical fixed reference point, a second configuration wherein the plurality of micro-louvers have varying depths relative to the vertical fixed reference point, and a third configuration wherein a spacing between adjacent ones of the plurality of micro-louvers varies relative to the vertical fixed reference point.

Additional features and advantages are realized through the techniques of exemplary embodiments of the present invention. Other embodiments and aspects of the invention are described in detail herein and are considered a part of the claimed invention. For a better understanding of the invention with advantages and features thereof, refer to the description and to the drawings.

### DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an exploded view of a computer display and a privacy device constructed in accordance with exemplary embodiments of the present invention;

FIG. 2 a front schematic view of the privacy screen of FIG. 1; and

FIG. 3 is a top schematic view of the privacy screen of FIG. 1.

The detailed description explains the exemplary embodiments of the invention, together with advantages and features thereof, by way of example with reference to the drawings.

### DETAILED DESCRIPTION OF THE INVENTION

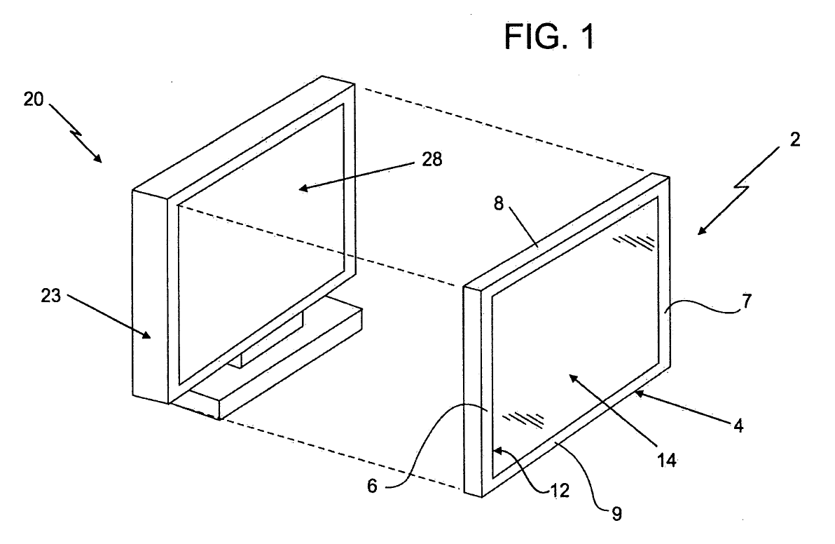

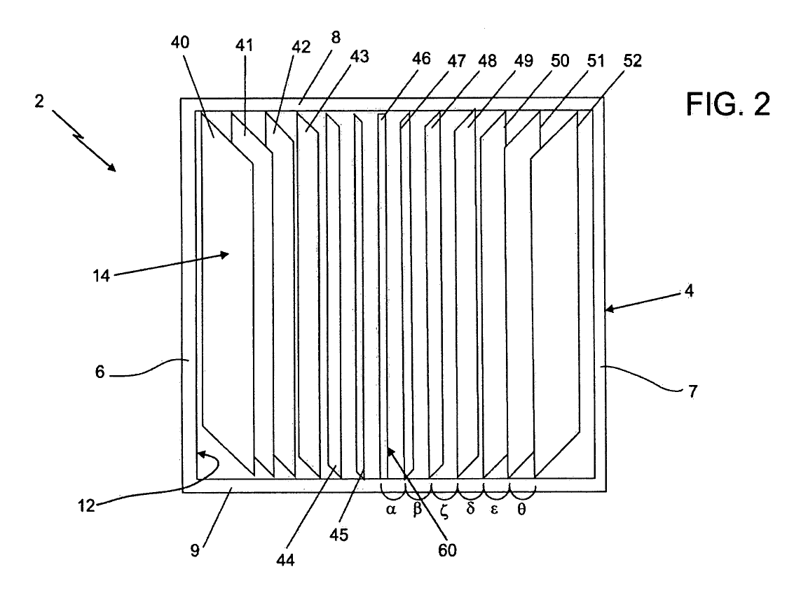

With initial reference to FIGS. 1 and 2, a privacy screen constructed in accordance with exemplary embodiments of the present invention is indicated generally at 2. Privacy screen 2 includes a frame 4 having first and second opposing frame members 6 and 7 that join with third and fourth opposing frame members 8 and 9 to collectively define a central opening 12. A transparent film 14 extends across central opening 12 and, as will be discussed more fully below, limits viewing angles for a display 20. That is, display 20 includes a main body 23 having a display screen 28. Privacy screen 2 is supported upon main body 23 across display screen 28. Individuals sitting at a particular focal point can readily view images presented on display screen 28. However, in a manner that will be described more fully below, individuals positioned at side portions of display 20 will have a limited view of the images presented on display screen 28.

As shown in FIG. 2, transparent film 14 includes a plurality of micro-louvers 40 through 52 with micro-louver 46 defining a vertical fixed reference point 60. At this point it should be understood that while vertical fixed reference point 60 is shown centrally on transparent film 14, other locations offset from a central axis of privacy screen 2 can also be employed. In accordance with one aspect of the invention, micro-louver 46 is positioned so as to extend parallel to a plane defined by first and second opposing side members 6 and 7. The remaining micro-louvers, i.e. micro-louvers 40-45 and micro-louvers 47-52 are positioned at variable angles relative to vertical fixed reference point 60. More specifically, as distance from vertical fixed reference point 60 increases, an angular position of each micro-louver 40-45 and 47-50 increases. For example, micro-louver 47 is configured at an angle α, micro-louver 48 is configured at an angle β which is greater than α, micro-louver 49 is positioned at an angle γ, micro-louver 50 is positioned at an angle δ, micro-louver 51 is positioned at an angle ε, and micro-louver 52 is positioned at an angle ζ. Angles α-ζ increase along a gradient proportional to a distance radiating outward from vertical fixed reference point 60. Of course, micro-louvers 40-45 are positioned at corresponding angles, 180 degrees out of phase from angles α-ζ. By arranging micro-louvers 40-52 at a variable angles along a gradient extending outward from vertical reference point 60, light emitted from display screen 28 will be at substantially a uniform intensity when viewed from a predefined focal point. Correspondingly, light viewed from side portions of display 20 will be substantially degraded. Thus, a user positioned at or near vertical fixed reference point 60 will be presented with a clear view of display 20 without suffering from side effects such as eye strain while users positioned at side portions of display 20 will be unable to view images presented on display screen 28.

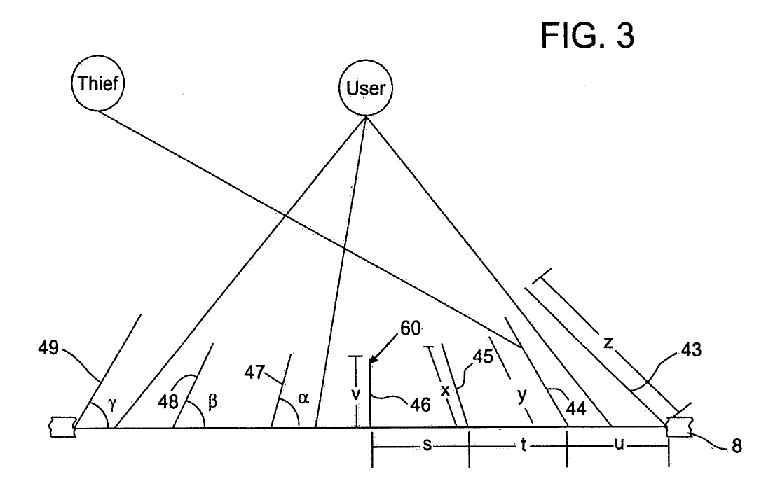

In accordance with another aspect of the present invention, each micro-louver 40-52 has a variable depth. Depth of a particular micro-louver 40-52 is measured along an axial surface from an first edge portion (not separately labeled) which is adjacent a surface of display screen 28 to an opposed edge portion regardless of micro-louver angle. As best shown in FIG. 3, micro-louver 46 has a depth v, micro-louver 45 has a depth x which is greater than depth v, micro-louver 44 has a depth y which is greater than depth x, and micro-louver 43 has a depth: z which is greater than depth y. Depths v through z increase as a distance from vertical fixed reference point 60 increases. By increasing the depth of each micro-louver 40-52, individuals positioned at side portions of display 20 will be unable to view images presented on display screen 28. At the same time, a user sitting at or near a particular focal point from display screen 20 will view images presented on display screen 28 with light intensity emanating from display 20 being substantially uniform across privacy screen 2.

In accordance with yet another aspect of the present invention, spacing between adjacent micro-louvers increases along a gradient extending out from vertical fixed reference point 60. That is, micro-louvers 46 and 45 are spaced a distance s, micro-louvers 45 and 44 are spaced at a distance t which is greater than distance s, and micro-louvers 44 and 43 are spaced at a distance u which is greater than distance t. Distances s-u increase as distance from vertical fixed reference point 60 increases. Increasing the spacing between adjacent micro-louvers ensures a constant light level at a user's eye. Combining variable angles, variable depths, and/or variable spacing, ensures that a user positioned at or near a focal point spaced from display 20 will be exposed to constant light levels emanating from display screen 28 while individuals positioned at side portions of display 20 will be unable to view images presented on display screen 28. The constant light level minimizes any need for constant eye adjustment thereby eliminating eye strain experienced by users of privacy screen 2. At this point, it should also be appreciated that micro-louvers 40-52 can be arranged at variable angles, variable depth, and/or variable spacing and combinations thereof.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A privacy screen for a display, comprising:
a frame including first and second opposing members joined by third and fourth opposing members that collectively define a central opening;
a transparent film extending across the central opening, the transparent film including a plurality of vertical micro-louvers, the plurality of micro-louvers being arranged in at least one of a first configuration wherein the plurality of micro-louvers are positioned at variable angles relative to a vertical fixed reference point, a second configuration wherein the plurality of micro-louvers have varying depths relative to the vertical fixed reference point, and a third configuration wherein a spacing between adjacent ones of the plurality of micro-louvers varies relative to the vertical fixed reference point.

2. The privacy screen according to claim 1, wherein the plurality of micro-louvers are arranged in at least two of the first, second and third configurations.

3. The privacy screen according to claim 2, wherein the plurality of micro-louvers are arranged in each of the first, second and third configurations.

4. The privacy screen according to claim 1, wherein the vertical fixed reference point is arranged at a midpoint of the central opening.

5. The privacy screen according to claim 1, wherein the variable angles increase in proportion to a distance from the vertical fixed reference point, the variable depths increase in proportion to a distance from the vertical fixed reference point and the spacing between adjacent ones of the plurality increasing in proportion to a distance relative to the vertical fixed reference point.
